(19) United States
(12) Patent Application Publication
(10) Pub. No.: US 2015/0206330 A1
(43) Pub. Date: Jul. 23, 2015

(54) WEATHER INFORMATION DISPLAY SYSTEM, HUMAN NAVIGATION DEVICE, AND METHOD OF DISPLAYING WEATHER INFORMATION

(71) Applicant: Furuno Electric Co., Ltd., Nishinomiya (JP)

(72) Inventors: Yoshiaki Takechi, Nishinomiya (JP); Masahiro Minowa, Nishinomiya (JP)

(21) Appl. No.: 14/417,781

(22) PCT Filed: Jun. 11, 2013
(86) PCT No.: PCT/JP2013/066050

§ 371 Date: Jan. 27, 2015

(30) Foreign Application Priority Data
Jul. 31, 2012 (JP) 2012-170071

(51) Int. Cl. G06T 11/60; G01S 19/13; G01S 13/95; H04W 4/02; G06T 11/20

(52) U.S. Cl. CPC G06T 11/60; H04W 4/027; G06T 11/203; G01S 13/95; G01S 19/13; H04W 4/046

(57) ABSTRACT

A weather information display system is provided, which can grasp pinpoint weather information around the weather information display system in real time. The weather information display system includes a radar device, an image creator, a position acquirer, and a display unit. The radar device acquires weather observation data. The image creator creates a weather radar image based on the weather observation data acquired by the radar device. The position acquirer is provided to a terminal device and acquires a position of the terminal device. The display unit is provided to the terminal device and uses the position acquired by the position acquirer to display the reference position and the weather radar image around the reference position for a current time point by superimposing them on a map.

### TECHNICAL FIELD

This disclosure relates to a weather information display system, which displays weather information by superimposing it on a map.

### BACKGROUND ART

Conventionally, as disclosed in Patent Documents 1 to 3, car navigation systems configured to superimpose weather information on a map have been known.

A map display device of Patent Document 1 acquires weather information indicating, for example, current and future rainfall probabilities, from a weather information center every fixed interval (e.g., everyday). The map display device can display, for example, a rainfall probability around the map display device by superimposing it on a map, based on the received weather information. Moreover, the map display device can display, not only a current position of the map display device and a current rainfall probability, but also a future position of the map display device, the future rainfall probability, and the like, by superimposing them on the map.

A navigation device of Patent Document 2 acquires weather information similar to that described above through an FM broadcast. The navigation device can display a future rainfall probability, etc. by superimposing them on a map, and can also create a route that does not encounter rain, by taking the future rainfall probability, etc. into consideration.

A reception processing device of Patent Document 3 acquires weather information similar to that described above through a data broadcast and can display it by superimposing it on a map. Moreover, it is disclosed that the reception processing device of Patent Document 3 is applicable to car navigation devices and also mobile phones.

### REFERENCE DOCUMENTS OF CONVENTIONAL ART PATENT DOCUMENT(S)

Patent Document 1: JP2003-121172A

Patent Document 2: JP2000-258174A

Patent Document 3: JP2005-051748A

### DISCLOSURE OF THE INVENTION

### Problems to be Solved by the Invention

Meanwhile, Patent Documents 1 to 3 have the configurations of acquiring the weather information for a long period (e.g., for one day) before use, and performing a display utilizing the weather information. Therefore, with this configuration, it is difficult to accurately grasp the weather for about a few dozen minutes later. Moreover, since the weather information acquired in Patent Documents 1 to 3 is a type of predicted information in which the rainfall probability, etc. per a few hours are displayed, even when the information is often received from the weather information center, etc., the weather for about a few dozen minutes later similarly cannot be grasped accurately. Therefore, the conventional configurations have not been able to accurately predict an evening rain shower, a concentrated heavy rain (short localized downpour) or the like that may happen suddenly.

Moreover, the type of weather information described above is only provided for a wide area (e.g., per city), and therefore, a pinpoint weather, such as where in the relevant city the rain falls, cannot be grasped. Therefore, the conventional configurations have not been able to answer a demand of wanting to surely avoid the rain. Further, it has been difficult to apply the conventional configurations to a human navigation device, etc.

This disclosure is made in view of the above situations and aims to provide a weather information display system, which can grasp pinpoint weather information around the system in real time.

### SUMMARY AND EFFECTS OF THE INVENTION

Problems to be solved by the present disclosure are described above, and means for solving the problems and effects thereof will be described below.

According to a first aspect of this disclosure, a weather information display system having the following configuration is provided. Specifically, the weather information display system includes a radar device, an image creator, a position acquirer, and a display unit. The radar device acquires weather observation data. The image creator creates a weather radar image based on the weather observation data acquired by the radar device. The position acquirer is provided to a terminal device and acquires a position of the terminal device. The display unit is provided to the terminal device and uses the position acquired by the position acquirer as a reference position to display the reference position and the weather radar image around the reference position for a current time point by superimposing them on a map.

Thus, the weather radar image for the current time point is displayed on the terminal device, and therefore, weather information can be provided to a user in real time. Moreover, a positional relationship between a rain cloud, etc. and the terminal device can be understood, and therefore, pinpoint weather information can be provided to the user.

The weather information display system preferably has the following configuration. Specifically, the weather information display system includes a plurality number of the radar devices, and a management unit configured to receive either one of the weather observation data and the weather radar image from the plurality number of radar devices and, in response to a request from the terminal device, transmit the either one of the weather observation data and the weather radar image.

Thus, compared to a configuration in which the radar device and the terminal device perform a direct communication with each other, an integrated management can be performed.

With the weather information display system, the display unit preferably displays concentric range rings centering on the reference position.

Thus, the user can easily grasp a distance from a current position to the rain cloud.

The weather information display system preferably has the following configuration. Specifically, the weather information display system includes a predictor configured to predict a change of weather when a time point is shifted forward. Moreover, the display unit is able to display the weather radar image for after the forward shifting of the time point.

Thus, the user can grasp a moving direction of the rain cloud, etc., and therefore, the user can determine, for example, which direction if he/she moves, he/she will not encounter rain.

The weather information display system preferably has the following configuration. Specifically, the terminal device is able to detect a first operation that is an operation for moving the reference position. When the first operation is detected, the display unit displays the moved reference position and the weather radar image for after the forward shifting of the time point.

Thus, the user can accurately determine whether he/she will encounter rain if he/she moves on a specified route.

The weather information display system preferably has the following configuration. Specifically, the terminal device includes an inclination sensor that is able to obtain an inclination of the terminal device. The terminal device detects, as the first operation, an operation of inclining the terminal device in a predetermined direction.

Thus, the user can move the reference position with the simple operation. Particularly, the operations described above can be performed with one hand, and therefore, he/she can perform them easily even while holding an umbrella with the other hand.

The weather information display system preferably has the following configuration. Specifically, the terminal device is able to detect a second operation that is an operation for shifting the time point forward without moving the reference position. When the second operation is detected, the display unit displays the unchanged reference position and the weather radar image for after the forward shifting of the time point.

Thus, the route can be created even for a case of determining a departure time point when the user is currently in the rain, a case of taking shelter from the rain on the way to a destination, etc.

The weather information display system preferably has the following configuration. Specifically, the terminal device includes an inclination sensor that is able to obtain an inclination of the terminal device. The terminal device detects, as the second operation, an operation of inclining the terminal device in a predetermined direction while performing a predetermined operation.

Thus, the user can shift the time point forward with the simple operation. Particularly, the operations described above can be performed with one hand, and therefore, he/she can perform them easily even while holding an umbrella with the other hand.

With the weather information display system, the terminal device preferably creates and stores a route based on a moving history of the reference position.

Thus, the user can create the route by taking a status of the rain cloud, his/her schedule, etc. into consideration. Therefore, the user can easily move on the route created by himself/herself.

The weather information display system preferably has the following configuration. Specifically, the weather information display system includes a GNSS device configured to receive signals from GNSS satellites. The predictor predicts the change of the weather when the time point is shifted forward, based on a detection result of the GNSS device and a detection result of the radar device.

Thus, an amount of water contained within air can be understood based on delay amounts of the signals from the GNSS satellites, etc. Therefore, a more accurate prediction can be performed.

With the weather information display system, the display unit preferably changes a display mode of a mark indicating the reference position, when the weather radar image overlaps with the reference position.

Thus, the user can clearly know that he/she will encounter rain.

The weather information display system preferably has the following configuration. Specifically, the weather observation data contains rain information. The display unit displays at least one of a position that requires attention due to an influence of rain and a position of a facility where rain can be avoided.

Thus, the user can create a route that avoids near a river with a possibility of flooding, or a route that includes taking shelter from the rain in a facility of his/her preference.

According to a second aspect of this disclosure, a human navigation device having the following configuration is provided. Specifically, the human navigation device includes a communication unit, a position acquirer, and a display unit. The communication unit receives a weather radar image that is an image created based on weather observation data acquired by a radar device. The position acquirer acquires a position of the human navigation device. The display unit uses the position acquired by the position acquirer as a reference position to display the reference position and the weather radar image around the reference position for a current time point by superimposing them on a map.

Thus, pinpoint weather information can be provided to a user in real time.

According to a third aspect of this disclosure, the following method of displaying weather information is provided. Specifically, the method of the displaying weather information includes causing a radar device to acquire weather observation data, creating a weather radar image based on the weather observation data, acquiring a position of a terminal device, and using, as a reference position, the position acquired by acquiring the position of the terminal device to display the reference position and the weather radar image around the reference position for a current time point by superimposing them on a map.

Thus, pinpoint weather information can be provided to a user in real time.

### BRIEF DESCRIPTION OF DRAWINGS

FIG. 1 is a block diagram illustrating an overall configuration of a weather information display system.

FIG. 2 shows views illustrating display contents when a route search is performed in a first situation.

FIG. 3 shows views illustrating display contents when a route search is performed in a second situation.

FIG. 4 shows views illustrating display contents when a route search is performed in the second situation.

FIG. 5 shows views for describing an operation method using an inclination sensor.

### MODE(S) FOR CARRYING OUT THE INVENTION

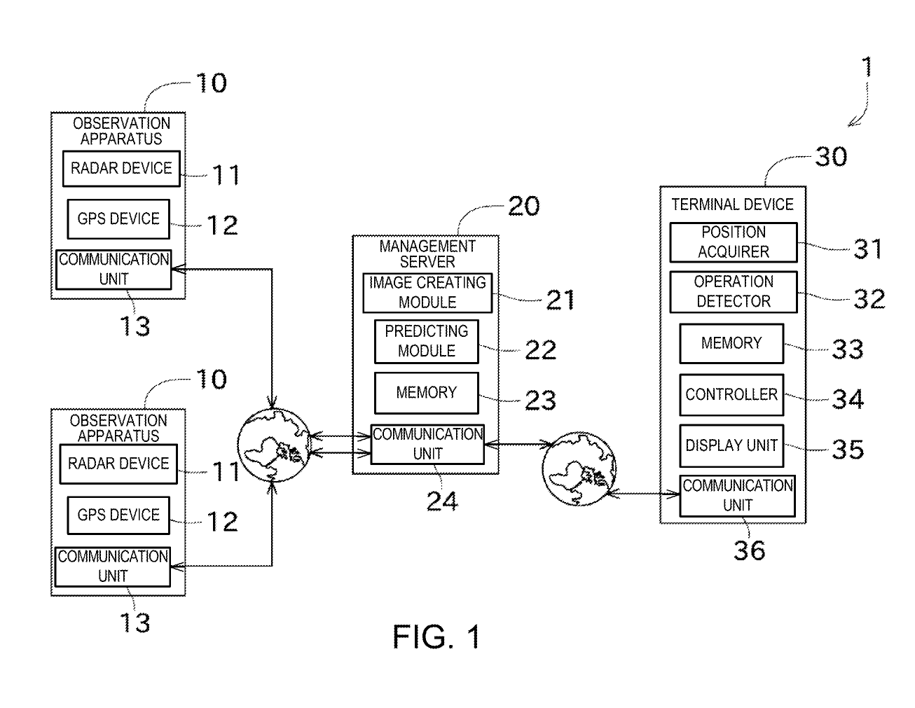

Next, an embodiment of this disclosure is described with reference to the drawings. FIG. 1 is a block diagram illustrating an overall configuration of a weather information display system 1.

The weather information display system 1 of this embodiment displays, on a terminal device 30, such as a smartphone possessed by a user, weather information by superimposing it on a map. Compared to the conventional configurations, the weather information display system 1 can provide detailed weather information (pinpoint weather information) of neighborhood of the user in real time. Therefore, the weather information display system 1 can determine whether a pedestrian encounters rain when he/she moves on a certain route, and can search for a route so that the pedestrian does not encounter the rain.

Hereinafter, a specific configuration of the weather information display system 1 is described. As illustrated in FIG. 1, the weather information display system 1 includes observation apparatuses 10, a management server (management unit) 20, and the terminal device 30.

Each of the observation apparatuses 10 is installed on, for example, a rooftop of a building, and observes rain cloud, etc. within an area of about a few dozen km from the installation position. The observation apparatus 10 includes a radar device 11, a GPS device 12, and a communication unit 13. The observation apparatus 10 acquires weather observation data. The weather observation data is related to weather and contains rain information, thunder information, tornado information, etc. Note that, in FIG. 1, only two observation apparatuses 10 are illustrated; however, actually a larger number of observation apparatuses 10 constitute the weather information display system 1.

The radar device 11 includes a transceiver and a radar antenna. The transceiver can generate radio waves by a control circuit, a magnetron, etc. The radar antenna discharges outside the radio waves generated by the transceiver. The radio waves discharged from the radar antenna reflect on a rain drop, rain cloud, etc. and are received by the radar antenna. By the transceiver, an amplification, a frequency down-conversion, etc. are performed on each of the reflection waves received by the radar antenna.

The following matters can be obtained based on the reflection wave. Specifically, a distance to the rain cloud, etc. can be obtained based on a time length from the transmission of the radio wave to the reception thereof by the radar antenna. Moreover, a direction in which the rain cloud, etc. exist can be obtained based on an elevation angle and an azimuth angle of the radar antenna when the radio wave is transmitted. Furthermore, when the elevation angle is increased, a position of the rain cloud in the air, an amount of water contained in the rain cloud, and the like can be obtained. On the other hand, when the elevation angle is reduced, an amount, size and the like of the rain drop that is actually currently falling can be obtained. Further, a velocity (speed and direction) of the rain cloud, etc. can be obtained by using that the frequency of the reflection wave is different depending on a difference in moving speed of the rain cloud, etc. (Doppler processing).

The GPS device (GNSS device) 12 includes a GPS antenna and a GPS receiver. The GPS receiver can calculate a position of the GPS device 12 by receiving and analyzing positioning signals from GPS satellites. Moreover, it is known that a time length until each positioning signal arrives is in a correlative relationship with an amount of water within air. In this embodiment, the amount of water within air is obtained based on the correlative relationship.

Note that, the processing of analyzing the reflection wave of the radar device 11, the processing of obtaining the amount of water based on the time length until the positioning signal arrives, etc. may be performed on the observation apparatus 10 side or the management server 20 side.

The communication unit 13 is able to communicate over internet, etc. and transmits, to the management server 20, either one of the weather observation data obtained by the radar device 11 and the GPS device 12 and data obtained by processing the weather observation data. Note that, alternative to the configuration in which the observation apparatus 10 transmits the weather observation data, etc. to the management server 20, a configuration in which the observation apparatus 10 transmits the weather observation data, etc. to the terminal device 30 may be adopted.

The management server 20 is installed in, for example, a company that provides the weather information display system 1. The management server 20 performs an overall control regarding the plurality of observation apparatuses 10, the terminal device 30, etc. The management server 20 includes an image creating module 21, a predicting module 22, a memory 23, and a communication unit 24.

The image creating module 21 creates a weather radar image based on the weather observation data of the observation apparatuses 10. The weather radar image is a radar image created based on the reflection waves received by the radar device 11 (including at least one of the reflection wave when the elevation angle is large and the reflection wave when the elevation angle is small). It may be such that only the rain cloud with a high possibility of causing a short localized downpour is displayed through performing, for example, threshold processing on the radar image.

The predicting module 22 predicts a change of the weather when a time point is shifted forward. Specifically, the predicting module 22 predicts a moving direction of the rain cloud based on the velocity of the rain cloud obtained from the Doppler processing. Moreover, the predicting module 22 predicts a developing status of the rain cloud based on the amount of water of the rain cloud acquired by the radar device 11, the amount of water acquired by the GPS device 12, etc. In this embodiment, since the movement of the rain cloud and the like are predicted based on a current radar image instead of a weather forecast performed before use as above, an extremely highly accurate prediction can be performed.

The memory 23 stores information of a position that requires attention due to the influence of rain (cautioning information). The cautioning information includes information of near a river, a street that is easily flooded, a location where a landslide disaster easily occurs, etc. Moreover, the management server 20 can estimate a total rainfall amount at an arbitrary location based on the weather radar image obtained in the past. Thus, for example, whether the river has overflowed can be determined and whether the cautioning to the user is required can be determined.

Moreover, the memory 23 also stores information of facility(ies) where the rain can be avoided (rain-shelter information). Rain-shelter information includes names, positions, work hours, and introduction sentences of shops, restaurants, amusement centers and the like.

The communication unit 24 can communicate with each observation apparatus 10 and the terminal device 30 over internet, etc. The management server 20 transmits, to the terminal device 30, the weather radar image, the predicted information thereof, the cautioning information, the rain-shelter information and the like.

The terminal device 30 is an instrument possessed by the user who uses the weather information display system 1 and, specifically, it is a mobile phone, a smartphone, a tablet terminal device, a human navigation device, etc. Note that, the human navigation device means a terminal device having a function for navigating either one of a person and a bicycle, and the concept of the human navigation device includes, not only a so-called navigation device (dedicated device), but also a smartphone installed with an application for navigation, etc. The terminal device 30 includes a position acquirer 31, an operation detector 32, a memory 33, a controller 34, a display unit 35, and a communication unit 36. Note that, in FIG. 1, only one terminal device 30 is illustrated; however, actually a larger number of terminal devices 30 constitute the weather information display system 1.

The position acquirer 31 is configured with, for example, a GPS reception device, and can calculate a position of the terminal device 30 by receiving and analyzing the positioning signals from the GPS satellites. Moreover, the position acquirer 31 is not limited to have the configuration of utilizing the GPS satellites, and may have a configuration of acquiring the position based on, for example, identification information of a base station of a communication facility, or a configuration of acquiring the position based on, for example, an MAC address of a wireless LAN router.

The operation detector 32 detects the operation performed on the terminal device 30 by the user. The operation detector 32 detects that a key of the terminal device 30 is operated, a touch operation is performed in a case where the terminal device 30 is a touch-panel type, and the like. Moreover, in this embodiment, the terminal device 30 has an acceleration sensor (inclination sensor) that can obtain an inclination of the terminal device 30. Therefore, the operation detector 32 can detect at what speed and in which direction the terminal device 30 is inclined, etc.

The memory 33 stores data of an application of the weather information display system 1 on the terminal device 30 side (hereinafter, simply referred to as the application), map information, etc. Moreover, the memory 33 stores the route created by using the weather information display system 1. Note that, a method of creating the route by using the weather information display system 1 is described later.

The controller 34 is configured with, for example, a CPU, and it performs processing based on the operation detected by the operation detector 32, etc. Also, the controller 34 performs processing of executing the application of the weather information display system 1.

The display unit 35 is a display of, for example, a liquid crystal type or an organic-EL type, and it can display the images created by the management server 20, the controller 34, etc. The communication unit 36 can transmit the positional information of the terminal device 30 to the management server 20 and receive the weather radar images, etc. from the management server 20.

Next, processing performed by the controller 34 when activating the application is described.

The controller 34 acquires the position of the terminal device 30 from the position acquirer 31 after the application is activated. Then, the controller 34 transmits the position of the terminal device 30 to the management server 20 via the communication unit 36.

The management server 20 receives the position and transmits, to the terminal device 30, a weather radar image corresponding to the received position, predicted information thereof, cautioning information (if the cautioning is needed), the rain-shelter information, and the like.

Based on the received data, the controller 34 displays the weather radar image, the cautioning information, the rain-shelter information and the like on the display unit 35 by superimposing them on the map, along with the position of the terminal device 30.

Next, a screen displayed on the display unit 35 during the execution of the application is described.

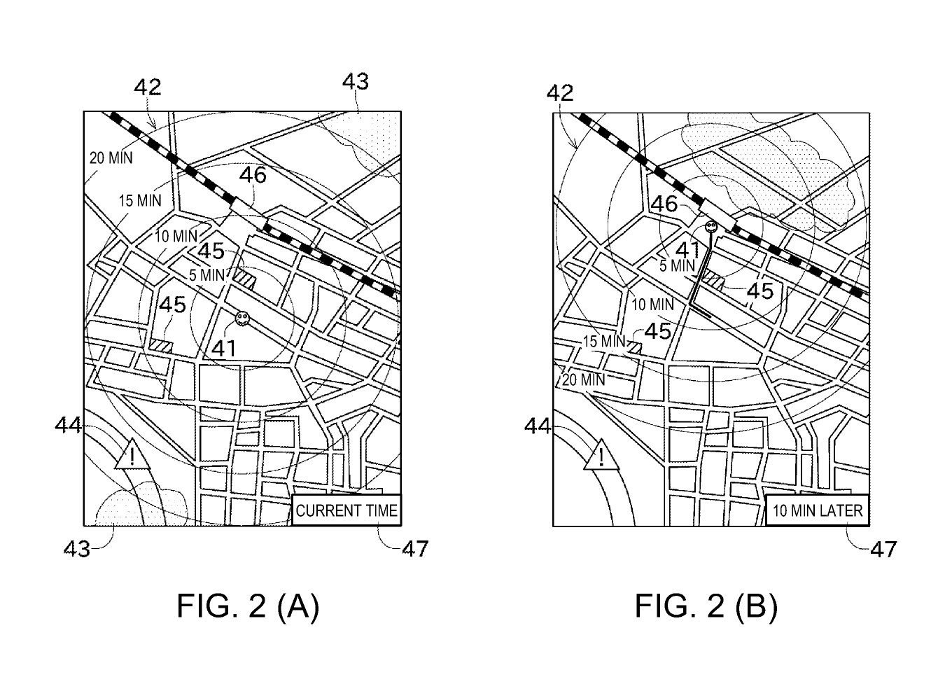

FIG. 2(A) displays the screen of the display unit 35 immediately after the application is activated. In this screen, a reference position mark 41, range rings 42, weather radar images 43, a caution mark 44, facility marks 45, a station mark 46, and a time displaying section 47 are displayed.

The reference position mark 41 is a mark indicating a reference position, and it indicates the position of the terminal device 30 immediately after the application is activated. Note that, in this embodiment, as illustrated in FIG. 2(B), the reference position can be moved while shifting the time point forward.

The range rings 42 are concentric circular sections centering on the reference position mark 41. In each range ring 42, a required period of time for the user to move straight to the position of the range ring 42 is displayed. Note that, by setting, for example, whether the user's means of transportation is walking or a bicycle, etc., a value corresponding to the means of transportation is displayed as the time period displayed in the range ring 42.

The weather radar images 43 are formed by superimposing the weather radar images created by the image creating module 21 of the management server 20. The weather radar images 43 are displayed on the upper right section and the lower left section of FIG. 2(A). Note that, in FIG. 2 and the drawings thereafter, only the rain clouds with the high possibility of causing the short localized downpour are displayed.

The caution mark 44 is displayed in the lower left section (near the river) of FIG. 2(A). The caution mark 44 is transmitted to the terminal device 30 and displayed thereon when the management server 20 determines as necessary based on the total rainfall amount. Two facility marks 45 are displayed near the center of FIG. 2. Note that, the user selects one of the facility marks 45 to display information, such as the name and work hours of the facility mark 45.

The station mark 46 is a mark indicating a user's destination station in the description of this case. The time displaying section 47 indicates how many minutes from a current time point that the displayed weather radar image 43 is for. For example, in FIG. 2(A) indicating immediately after the application is activated, “current time” is displayed in the time displaying section 47, and thus, it can be understood that the current weather radar image 43 is displayed. Moreover, in FIG. 2(B), “10 min later” is displayed in the time displaying section 47, and thus, it can be understood that the weather radar image 43 for 10 minutes later is displayed.

Next, a flow for searching a route by utilizing the application is described. First, a case where the user travels to the station in a first situation (the situation in FIG. 2(A)) is considered.

Here, as illustrated in FIG. 2(A), a linear distance to the station is about 10 minutes, and the rain clouds are about 20 minutes away in a linear distance. It is assumed that the user takes the linear distances into consideration and determines that “I can reach to the station without encountering the short localized downpour if I depart now.”

The user can confirm that his/her determination is correct by virtually moving the reference position (reference position mark 41). The moving speed of the reference position is set as described above, and the weather radar image 43 moves by a period of time corresponding to a moved amount of the reference position. Note that, the weather radar image 43 is moved based on the change of the weather predicted by the predicting module 22.

In FIG. 2(B), a situation when the reference position reaches the position of the station by being moved is displayed. As it is obvious from FIG. 2(B), although the rain cloud is closer to the reference position, it has not reached to the reference position. In the above manner, the user can confirm that the determination “I can reach to the station without encountering the short localized downpour if I depart now” is correct.

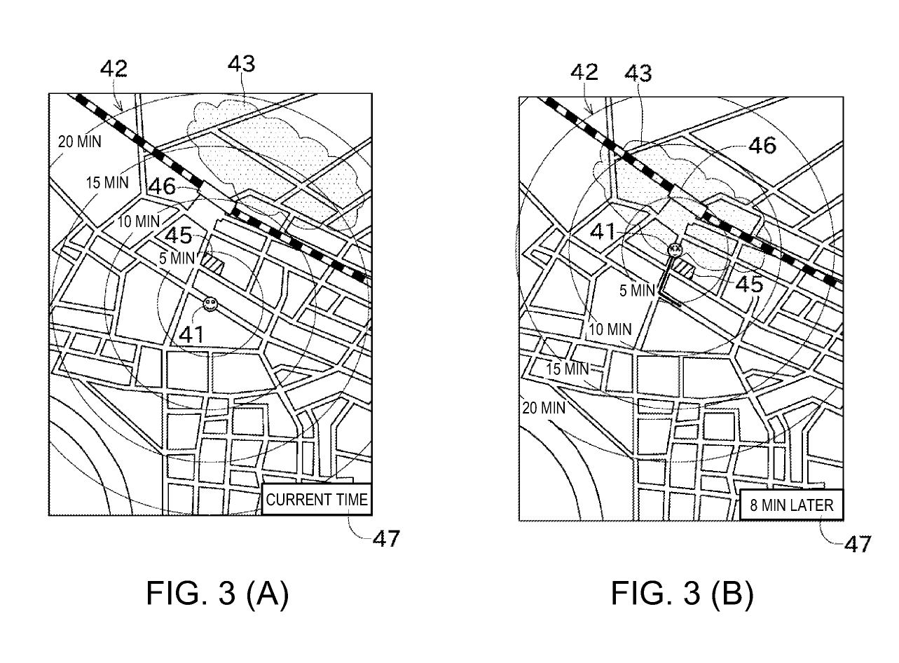

Next, a case where the user travels to the station in a second situation (the situation in FIG. 3(A)) is considered.

Here, as illustrated in FIG. 3(A), since the rain cloud is about 10 minutes away in a linear distance (near the station), when the rain cloud moves to the direction of the user, the user will encounter the short localized downpour. It is assumed that the user virtually moves the reference position (reference position mark 41) similarly to the above case, so as to check whether he/she will encounter the short localized downpour and where he/she will encounter the short localized downpour if he/she encounters the short localized downpour.

In FIG. 3(B), a situation when the reference position and the rain cloud are overlapped with each other while the reference position is brought closer to the station is displayed. Here, in this embodiment, the expression of the reference position mark 41 is changed to explicitly indicate that it is overlapped with the rain cloud. Note that, instead of the configuration of changing the expression, a configuration of notifying the user by a change of color of the reference position mark 41, turning the display of the reference position mark 41 on and off, etc. may be adopted.

As illustrated in FIG. 3(B), the user encounters the short localized downpour if he/she departs for the station at the current time point. As a method of avoiding the encounter, for example, departing after the short localized downpour passes, moving to bypass the short localized downpour, taking shelter from the rain on the way, etc. can be considered. Here, it is assumed that the user selects to take shelter from the rain at the facility near the encountering position with the short localized downpour.

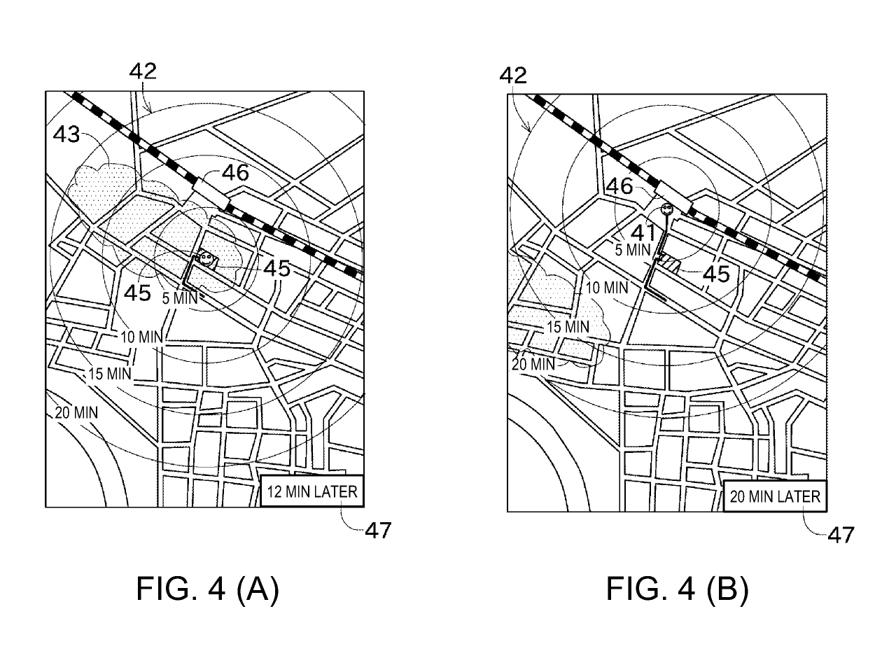

Therefore, the user slightly moves the reference position to return to the inside of the facility mark 45 (time point accordingly shifts back) from the state in FIG. 3(B). Then, the user only shifts the time point forward without changing the reference position (e.g., see FIG. 4(A)). Then, after the rain cloud passes, the user moves the reference position mark 41 toward the station again. In this manner, the creation of the route to the station while avoiding the encounter of the short localized downpour is completed. Thus, in this embodiment, the route can be determined through trial while referring to the change of the weather with time.

Note that, the controller 34 of the terminal device 30 creates the route based on a history of virtually moving the reference position as described above (moving history). For example, in the example in FIG. 2, the controller 34 creates the route to be the thick line in FIG. 2(B) that is the history of the reference position moved by the user. Moreover, in the example of FIGS. 3 and 4, the controller 34 creates the route to be the thick line in FIG. 4(B) that is the final route created by the user after the trial and error. Note that, the controller 34 stores in the memory 33 the route created as described above. Thus, the user can easily move on the created route.

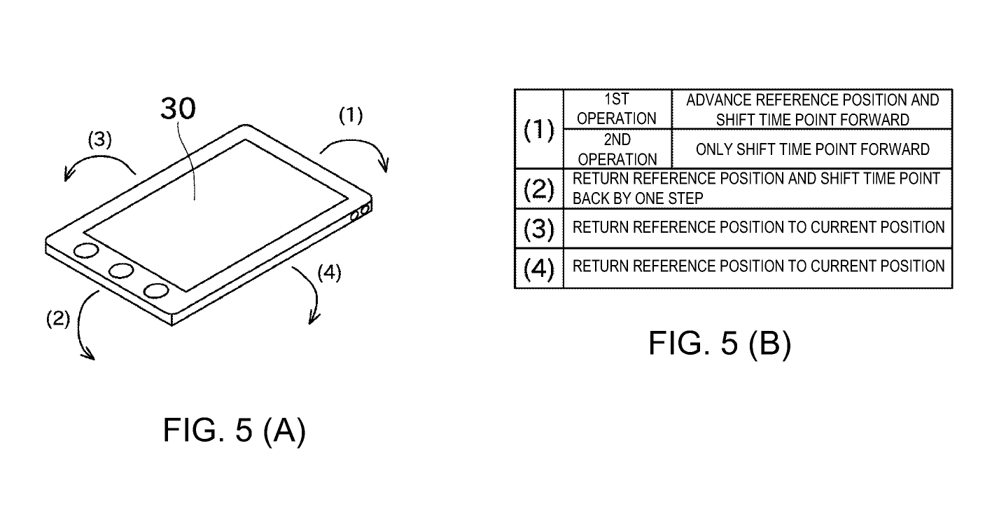

Next, a method of performing the operations when creating the route is described. FIG. 5 shows views for describing the operating method using the inclination sensor.

As described above, when creating the route, operations, such as advancing the reference position, returning the reference position, shifting only the time point forward while leaving the reference position as it is, are required. In this embodiment, by using the inclination sensor, these operations can be performed instinctively and easily.

In FIG. 5(A), the terminal device 30 and the direction of inclining the terminal device 30 are illustrated. Hereinafter, in FIG. 5(A), operation of inclining the terminal device 30 in the direction of (1) (forward) is referred to as a forward inclining operation, operation of inclining the terminal device 30 in the direction of (2) (rearward) is referred to as a rearward inclining operation, and each of operations of inclining the terminal device 30 in the directions of (3) and (4) (sideways) is referred to as a sideway inclining operation.

In FIG. 5(B), processing that is executed when the respective operations are performed is indicated. Here, first and second operations are assigned for the forward inclining operation of (1). The first operation is an operation of simply performing the forward inclining operation without touching the screen, and the second operation is an operation of performing the forward inclining operation in a state of touching the screen. Note that, the second operation is not limited to this, and it may be an operation of performing the forward inclining operation after a predetermined key is pressed (or in a state of pressing the predetermined key).

By performing the first operation of the forward inclining operation in (1), the reference position can be advanced (the time point simultaneously shifts forward). By performing the second operation of (1), only the time point can be shifted forward without advancing the reference position. By assigning the two operations for shifting the time point forward to the forward inclining operation as above, the operating method that is instinctively easy to understand can be achieved.

By performing the rearward inclining operation in (2), the advanced reference position can be returned by one step (the time point simultaneously shifts back). By inclining the terminal device to the opposite side to the operation side for advancing the reference position as above, the reference position can be returned, and thus, the operating method that is instinctively easy to understand can be achieved.

By performing the sideway inclining operation in (3) and (4), the advanced reference position can be returned to the current location (the time point simultaneously shifts back to the current time point).

Note that, the operating method given here is an example and can be changed suitably. For example, a configuration in which the reference position is advanced (returned) by two steps instead of one step by performing the forward inclining operation (rearward inclining operation) rapidly (or at a large angle) may be adopted. Moreover, a configuration of moving the reference position in the direction in which the terminal device 30 is inclined may be adopted.

As described above, the weather information display system 1 of this embodiment includes the radar device 11, the image creating module 21, the position acquirer 31, and the display unit 35. The radar device 11 acquires the weather observation data. The image creating module 21 creates the weather radar image based on the weather observation data acquired by the radar device 11. The position acquirer 31 is provided to the terminal device 30 and acquires the position of the terminal device 30. The display unit 35 is provided to the terminal device 30 and uses the position acquired by the position acquirer 31 as the reference position to display the reference position and the current weather radar image around the reference position by superimposing them on the map.

Thus, the current weather radar image is displayed on the terminal device, and therefore, the weather information can be provided to the user in real time. Moreover, since the positional relationship of the weather radar image indicating the rain cloud, etc. with the terminal device can be understood, the pinpoint weather information can be provided to the user.

Although the preferred embodiment of this disclosure is described above, the above configuration may be modified as follows.

The weather information display system 1 described above is an example, and a part of the processing performed by the observation apparatus 10 may be performed by either one of the management server 20 and the terminal device 30, a part of the processing performed by the management server 20 may be performed by either one of the observation apparatus 10 and the terminal device 30, or a part of the processing performed by the terminal device 30 may be performed by either one of the observation apparatus 10 and the management server 20.

The above embodiment has the configuration of detecting the positional information and the amount of water within air based on the signals from the GPS satellites; however, it may suitably be changed as long as it is a configuration of utilizing a GNSS (Global Navigation Satellite System). For example, a configuration of performing similar processing based on signals from GLONASS satellites or GALILEO satellites may be adopted.

In the above description, this disclosure is applied to the system configured to navigate either one of pedestrians and bicycles; however, this disclosure may also be applied to navigation systems for vehicles, ships, etc.

DESCRIPTION OF REFERENCE NUMERAL(S)
10 Observation Apparatus
11 Radar Device
12 GPS Device (GNSS Device)
13 Communication Unit
20 Management Server (Management Unit)
30 Terminal Device
41 Reference Position Mark
42 Range Ring
43 Weather Radar Image

1. A weather information display system, comprising:
a radar device configured to acquire weather observation data;
an image creator configured to create a weather radar image based on the weather observation data acquired by the radar device;
a position acquirer provided to a terminal device and configured to acquire a position of the terminal device; and
a display unit provided to the terminal device and configured to use the position acquired by the position acquirer as a reference position to display the reference position and the weather radar image around the reference position for a current time point by superimposing them on a map.

2. The weather information display system of claim 1, comprising:
a plurality number of the radar devices; and
a management unit configured to receive either one of the weather observation data and the weather radar image from the plurality number of radar devices and, in response to a request from the terminal device, transmit the either one of the weather observation data and the weather radar image.

3. The weather information display system of claim 1, wherein the display unit displays concentric range rings centering on the reference position.

4. The weather information display system of claim 1, comprising a predictor configured to predict a change of weather when a time point is shifted forward,
wherein the display unit is able to display the weather radar image for after the forward shifting of the time point.

5. The weather information display system of claim 4, wherein the terminal device is able to detect a first operation that is an operation for moving the reference position, and
wherein when the first operation is detected, the display unit displays the moved reference position and the weather radar image for after the forward shifting of the time point.

6. The weather information display system of claim 5, wherein the terminal device includes an inclination sensor that is able to obtain an inclination of the terminal device, and
wherein the terminal device detects, as the first operation, an operation of inclining the terminal device in a predetermined direction.

7. The weather information display system of claim 4, wherein the terminal device is able to detect a second operation that is an operation for shifting the time point forward without moving the reference position, and
wherein when the second operation is detected, the display unit displays the unchanged reference position and the weather radar image for after the forward shifting of the time point.

8. The weather information display system of claim 7, wherein the terminal device includes an inclination sensor that is able to obtain an inclination of the terminal device, and
wherein the terminal device detects, as the second operation, an operation of inclining the terminal device in a predetermined direction while performing a predetermined operation.

9. The weather information display system of claim 5, wherein the terminal device creates and stores a route based on a moving history of the reference position.

10. The weather information display system of claim 4, comprising a GNSS device configured to receive signals from GNSS satellites,
wherein the predictor predicts the change of the weather when the time point is shifted forward, based on a detection result of the GNSS device and a detection result of the radar device.

11. The weather information display system of claim 1, wherein the display unit changes a display mode of a mark indicating the reference position, when the weather radar image overlaps with the reference position.

12. The weather information display system of claim 1, wherein the weather observation data contains rain information, and
wherein the display unit displays at least one of a position that requires attention due to an influence of rain and a position of a facility where rain can be avoided.

13. A human navigation device, comprising:
a communication unit configured to receive a weather radar image that is an image created based on weather observation data acquired by a radar device;
a position acquirer configured to acquire a position of the human navigation device; and
a display unit configured to use the position acquired by the position acquirer as a reference position to display the reference position and the weather radar image around the reference position for a current time point by superimposing them on a map.

14. A method of displaying weather information, comprising:
causing a radar device to acquire weather observation data;
creating a weather radar image based on the weather observation data;
acquiring a position of a terminal device; and
using, as a reference position, the position acquired by acquiring the position of the terminal device to display the reference position and the weather radar image around the reference position for a current time point by superimposing them on a map.
